(19) United States
(12) Patent Application Publication
(10) Pub. No.: US 2018/0040120 A1
(43) Pub. Date: Feb. 8, 2018

(54) METHODS FOR QUANTITATIVE ASSESSMENT OF MONONUCLEAR CELLS IN MUSCLE TISSUE SECTIONS

(71) Applicant: Flagship Biosciences, Inc., Westminster, CO (US)

(72) Inventors: Crystal Dawn Faelan, Louisville, CO (US); Anthony J. Milici, Branford, CT (US); Joshua C. Black, Aurora, CO (US); Nathan T. Martin, Broomfield, CO (US)

(73) Assignee: Flagship Biosciences, Inc., Westminster, CO (US)

(21) Appl. No.: 15/220,393

(22) Filed: Jul. 27, 2016

Related U.S. Application Data
(63) Continuation-in-part of application No. 14/983,296, filed on Dec. 29, 2015, now Pat. No. 9,784,665.
(60) Provisional application No. 62/097,543, filed on Dec. 29, 2014.

(51) Int. Cl. G06T 7/00; G06K 9/46; G06T 11/60; G01N 1/30

(52) U.S. Cl. CPC G06T 7/0012; G01N 1/30; G06K 9/4604; G06T 11/60; G06T 2207/30204; G06T 2207/30024; G06T 2207/10056

(57) ABSTRACT

In accordance with the embodiment described herein, we describe a method for evaluating muscle fiber nuclei and non-muscle fiber mononuclear cells, and biomarkers expressed within these and muscle fibers, within the context of muscle tissue using digital tissue image analysis. An algorithm process is applied to histologically stained tissue sections to extract the morphometric, staining, and localization features of a plurality of tissue objects. These features can be further analyzed to describe relationships between tissue objects or tissue object image analysis features. One or more of these image analysis features or relationships between objects and features are summarized to derive a patient-specific score. Patient stratification criteria are applied to the patient-specific score and patient strata membership is evaluated to infer presence of disease, natural course of disease, disease severity, treatment efficacy, or response to a therapy and eligibility for said therapy.

### CROSS-REFERENCE TO RELATED APPLICATIONS

This application is a continuation-in-part (CIP) of commonly owned U.S. Ser. No. 14/983,296, filed Dec. 29, 2015, titled “METHODS FOR QUANTITATIVE ASSESSMENT OF MUSCULAR FIBERS IN MUSCULAR DYSTROPHY”;

which claims benefit of priority with U.S. Provisional Ser. No. 62/097,543, filed Dec. 29, 2014, titled “METHODS FOR QUANTITATIVE ASSESSMENT OF MUSCULAR FIBERS IN MUSCULAR DYSTROPHY”; the contents of each of which are hereby incorporated by reference.

### BACKGROUND

### Field of the Invention

This invention relates to methods for assessing immunohistochemistry or immunofluorescence stained muscle tissue with digital image analysis for the purpose of evaluating myopathy disease status; specifically for digital image analysis-bases scoring of nucleated cells relative to muscle fibers in muscle tissues obtained from myopathy patients.

### Description of the Related Art

Myopathies categorize a group of genetic disorders which result in muscle dysfunction. Generally, myopathies include progressive weakening and wasting of skeletal muscle and may include failure of additional organ systems during disease progression. Myopathies typically derive from either altered gene expression and/or expression of mutated genes involved in the functional molecular components of neuronal or muscle cells.

Muscular dystrophies represent a group of myopathies that are incurable, significantly impair quality of life and are frequently fatal. The two most common forms of muscular dystrophies are Duchenne and Becker muscular dystrophies (DMD and BMD, respectively). In DMD and BMD, muscle fiber structural integrity is compromised due to a failure to produce functional dystrophin. Dystrophin acts a molecular shock absorber, distributing contractile force along the length of a muscle fiber and out into the surround connective tissue [Hoffman E P et al. Cell. 1987; 51:919-928]. In the absence of functional dystrophin, muscle fibers undergo cyclical damage resulting from the normal processes of contraction.

Muscle fiber damage triggers the cellular repair process, resulting in an influx of immune and inflammatory cells. Immune and inflammatory cells contribute to normal muscle repair through a highly regulated series of stages. In myopathies such as DMD and BMD, this process is disrupted, resulting in inappropriate accumulation of certain inflammatory cells (e.g., M1 macrophages) and inadequate presence of other inflammatory cells (e.g., M2 macrophages) [Madaro, L., & Bouché, M. BioMed Research International, 2014; 438675]. Dysregulation of this immune cycle contributes to the failure of muscle regeneration. Assessment of immune infiltrate within muscle samples can be used to infer myopathy severity.

Herein, we describe digital image analysis-based methods for quantitatively assessing nucleated and non-nucleated cells, and associated biomarker staining, in the spatial context of muscle fibers in muscle biopsy tissues. These methods significantly surpass the abilities of a manual observer with a microscope and current digital image analysis-based tools to quantify and relate nucleated and non-nucleated cell types or biomarkers relative to the spatial context and orientation of muscle fibers. For the purposes of example and not limitation, we illustrate the use of the methods described herein for assessing biomarker presence or expression level in mononuclear cells to determine the content and context of biomarker-expressing cells in the context of skeletal muscle fibers for the purposes of evaluating myopathy disease severity.

### SUMMARY

Herein described is a method for evaluating muscle fiber nuclei and non-muscle fiber mononuclear cells, and biomarkers expressed within these and muscle fibers, within the context of muscle tissue using digital tissue image analysis. An algorithm process is applied to histologically stained tissue sections to extract the morphometric, staining, and localization features of a plurality of tissue objects. These features can be further analyzed to describe relationships between tissue objects or tissue object image analysis features. One or more of these image analysis features or relationships between objects and features are summarized to derive a patient-specific score. Patient stratification criteria are applied to the patient-specific score and patient strata membership is evaluated to infer presence of disease, natural course of disease, disease severity, treatment efficacy, or response to a therapy and eligibility for said therapy.

### BRIEF DESCRIPTION OF THE DRAWINGS

FIG. 1 shows an overview of the method described herein for scoring biomarker expression status in patients submitted for evaluation using a digital image analysis algorithm process implemented by a computer.

FIG. 2 shows the process by which an algorithm process identifies tissue objects through object-based image analysis and extracts the staining, morphometric, and localization features of said tissue objects.

FIG. 3 illustrates the process by which an algorithm process implemented by a computer is applied to digital images of a dual stained tissue section to generate a nuclei mask for assessment of biomarker expression inside and outside the nuclear compartments of cell objects.

FIG. 4 illustrates the process by which a triple color stained tissue is evaluated by the algorithm process to evaluate biomarker expression inside and outside of muscle fibers and inside and outside of nuclei.

FIG. 5 illustrates the process by which a six-plex stained muscle tissue section is assessed by the algorithm process implemented by a computer to evaluate biomarker expression in the context of multiple tissue objects.

FIG. 6 demonstrates the process by which the algorithm process identifies the muscle fiber footprint based on muscle fiber cytoplasm-specific stain.

FIG. 7 illustrates some of the various tissue objects identified by the algorithm process including, but not limited to, muscle fiber, muscle fiber membrane, central muscle fiber nuclei, peripheral muscle fiber nuclei, and non-muscle fiber mononuclear cells.

FIG. 8 illustrates that each tissue object can be described by a plurality of image analysis features and that each tissue object can be subset into tissue object subsets which can also be described by a plurality of image analysis features.

FIG. 9 illustrates that one class of tissue objects can be related to one or more unique classes of tissue objects and the example of a distance relationship is given.

FIG. 10 demonstrates that image analysis features can be summarized for a specific object class over the tissue area covered by said object class, can be summarized on a muscle fiber cell-by-cell basis for tissue objects relating to the muscle fibers or sub-classes of objects associated with the muscle fibers, and can be summarized on a mono-nuclear cell-by-cell basis for mononuclear cell objects and sub-classes of objects.

### DETAILED DESCRIPTION OF EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention.

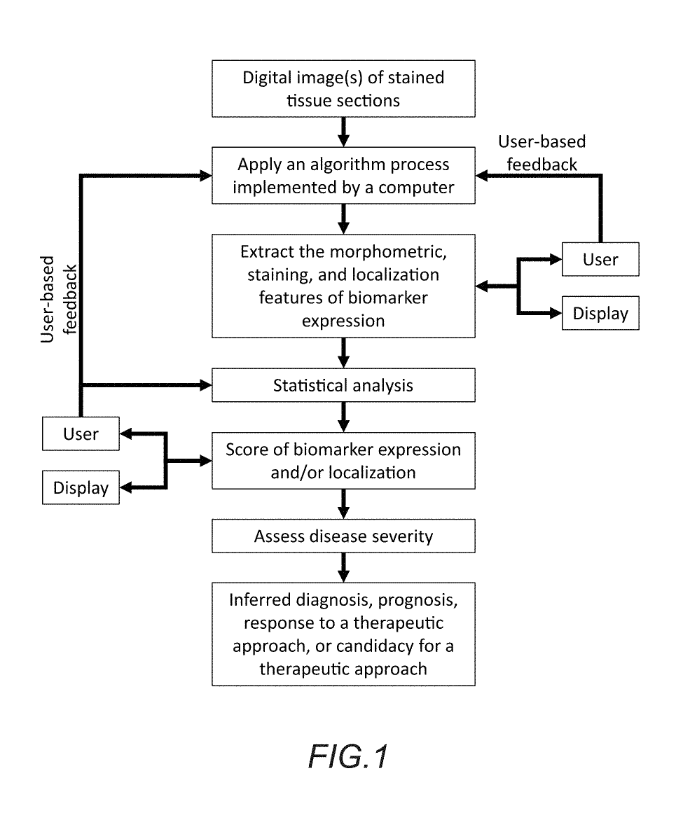

In an illustrative embodiment, the method for assessment of biomarker protein and/or transcript expression in nucleated and non-nucleated cells within muscle tissue using digital image analysis may generally comprise nine consecutive steps, including: 1) obtaining muscle tissue embedded in a tissue block from patients submitted for evaluation; 2) processing said tissue block using standard histologic procedures to generate one or more tissue sections attached to a glass histology slide; 3) contacting said tissue sections with one or more antibodies, nucleotide probes, and/or histologic stains to stain said tissue sections; 4) generating digital images of said stained tissue sections; 5) applying an algorithm process implemented by a computer to each digital image; 6) identifying tissue objects and extracting the staining, localization, and morphometric features of the tissue objects with said algorithm process; 7) relating one or more image analysis feature parameters and/or tissue object classes pertaining to a nucleated cell to one or more distinct tissue objects to derive a novel image analysis feature describing the relationship between the image analysis features and/or object classes and another unique object class; 8) assessing one or more of said novel features to score the disease status for each patient submitted for evaluation; and 9) using said score for the purpose of diagnosis, prognosis, monitoring treatment efficacy, or selecting patients for a specific therapeutic approach. FIG. 1 summarizes the process by which biomarker expression status is evaluated and scored using an algorithm process applied to images of stained muscle tissue submitted for evaluation.

For purposes of definition, a biomarker is one or more of: a protein, lipid, carbohydrate, and nucleotide sequence which, when evaluated and interpreted, leads to inferences regarding the underlying biological mechanisms, status, phenomena, or therapeutic represented in a tissue.

For purpose of definition, a tissue object is one or more of: a cell (e.g., immune, or muscle cell), cell sub-compartment (e.g., nucleus, cytoplasm, membrane, organelle, etc.), cell neighborhood, a tissue compartment (e.g., muscle fiber cluster of similar fiber sub-type, tissue section of skeletal muscle, etc.), blood vessel, and a lymphatic vessel. Tissue objects are visualized by histologic stains which highlight the presence and localization of a tissue object. Tissue objects can be identified directly by stains specifically applied to highlight said tissue object (e.g., hematoxylin to visualize nuclei, immunohistochemistry (IHC) stain for a protein specifically found in a muscle fiber membrane, etc.), indirectly by stains applied which non-specifically highlight the tissue compartment (e.g., DAB background staining), or are biomarkers known to be localized to a specific tissue compartment (e.g., nuclear-expressed protein, carbohydrates only found in the cell membrane, etc.).

### Tissue Acquisition and Generating a Tissue Section

Obtaining tissue for analysis entails collecting a processed biopsy sample from muscle tissue of a patient under evaluation. The tissue obtained from a patient is the “tissue sample,” and processing of the tissue sample may entail fixation of the tissue sample (e.g., using a fixative such as formalin), transporting the sample to a histology laboratory, and generating a tissue block in which the tissue has been embedded in a specified media (e.g., paraffin).

A similar process is followed in the collection and preparation of frozen tissue samples. For such samples, the tissue is rapidly frozen (e.g., in liquid nitrogen) and embedded in a specified freezing media (e.g., O.C.T.) instead of fixation media to produce a tissue block. In this alternative protocol, the tissue sample may be fixed pre- and/or post-freezing or not at all.

Once a tissue block is generated which contains the tissue sample, further processing steps are taken to generate a tissue section (e.g., cutting of the tissue block), which is adhered to a glass histology slide using standard and accepted histological procedures.

The tissue preparation process can have a considerable effect on how the tissue features of interest will be expressed in the tissue sections. Careful control needs to be applied to standardizing this process.

### Slide Staining

The slides staining process comprises standard and accepted histological procedures. The staining of the slides (i.e., Hematoxylin and Eosin—H&E, IHC, Immunofluorescence—IF, Chromogenic and Fluorescent In Situ Hybridization—CISH and FISH, respectively) highlights the specific tissue object features of interest in the muscle tissue samples. These features include, but are not limited to, highlighting biomarkers that identify the cell type (e.g., neuronal, immune, muscle, and vascular), structural and molecular components (e.g., muscle fiber membrane), and cellular compartments (e.g., nuclei) of muscle fibers and mononuclear cells.

In an illustrative embodiment of this invention, dual staining (e.g., IHC and/or IF) is performed to highlight IL-6 and IL-10 protein expression in mononuclear cells within the muscle tissue. IL-6 and IL-10 are specifically expressed in M1 and M2 macrophage membranes, respectively. M1 and M2 macrophages are important components of the inflammatory response in myopathies. Antibodies designed to specifically bind to each of these proteins are used to highlight the localization and expression of the proteins in tissue objects (e.g., cells) relative to other tissue objects (e.g., muscle fiber membranes).

In an embodiment of this invention, staining for one or more biomarkers-of-interest (e.g., IL-6, IL-10, etc.) are performed independently (e.g., one biomarker stain per tissue section). In another preferred embodiment of this invention, staining for the one or more biomarkers-of-interest are performed in the same muscle section (e.g., multiplexed staining of two or more biomarkers of interest). In a third preferred embodiment of this invention, staining for one or more biomarkers-of-interest are performed alongside staining for one or more biomarker that highlights the muscle fiber membrane (e.g., merosin, spectrin) and/or muscle fiber cytoplasm (e.g., myosin heavy chain staining). Additional histologic stains can be utilized in any of these embodiments to highlight additional tissue objects (e.g., nuclei highlighted by hematoxylin staining, blood vessels by an IHC marker for blood vessels, etc.).

Once each tissue section is stained, the section is further processed to finalize the preparation of the slide. The histology processing and staining process itself can have a considerable effect on how the cell features of interest are expressed in the tissue sections. Careful control needs to be applied to standardize this process.

### Slide Digitization

Histology slides can be digitized using commercially available digital microscopes coupled with a digital camera and slide scanners (e.g., Aperio, Cri, Hamamatsu, Leica, Omnyx, Philips, Ventana, 3DHistech). Different imaging acquisition techniques (e.g., bright-field, fluorescence, multi-spectral, polarized) can be used to create a digital image of a histology slide, resulting in multiple images for a single slide. The digitization of a slide can have a considerable effect on how the cell features of interest are imaged. Thus, careful control needs to be applied to standardize this process.

Digital Image Analysis of Biomarker Protein or Transcript Expression in Muscle Sections

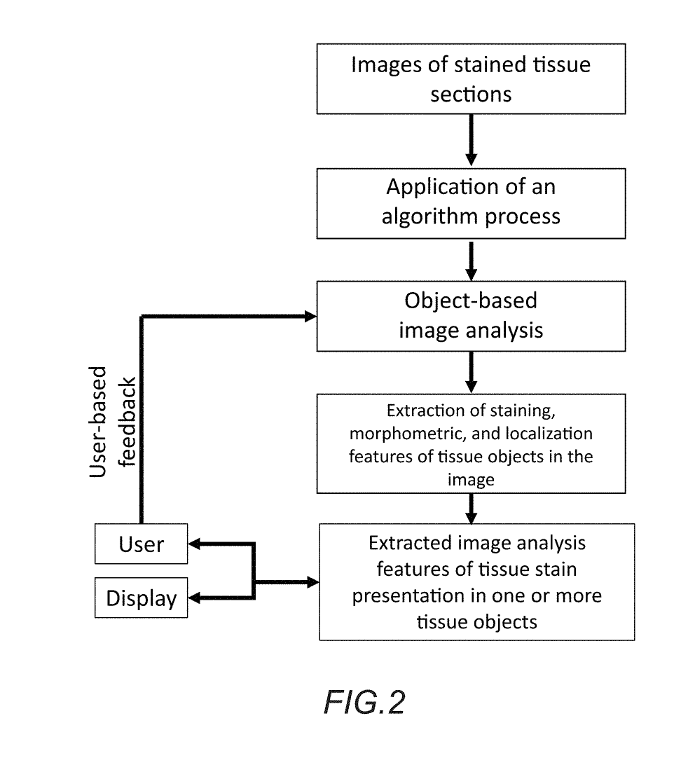

In a preferred embodiment of this invention, an algorithm process is applied to an image of a stained tissue section which was stained according to one of the descriptions above. The algorithm process identifies tissue objects (e.g., nuclei, muscle fibers, muscle fiber clusters, nucleated cell cytoplasm area, cell membranes, blood vessels, etc.). Tissue objects are identified and characterized by the algorithm process based on presentation of specific stains (e.g., hematoxylin, DAB, FITC, DAPI, etc.) and the morphometric (e.g., size, shape, etc.), staining (e.g., staining intensity, staining texture, etc.) and localization (e.g., x-y coordinates in image, etc.) features are extracted for each object by the algorithm process. FIG. 2 provides an outline of this preferred embodiment of the invention whereby the algorithm process is applied to an image of a stained tissue section to extract the morphometric, staining, and localization features of tissue objects.

In one embodiment of this invention, biomarker staining is evaluated inside and outside of nuclei (e.g., muscle fiber nuclei, M1 macrophage nuclei, M2 macrophage nuclei, etc.) by the algorithm process. In this embodiment, nuclei are identified by the algorithm based on a nuclear counterstain (e.g., DAPI, hematoxylin, etc.) and a nuclear mask is generated which captures the area and boundaries of each of the nuclei-objects identified by the algorithm process. This nuclei-object mask is then applied to the biomarker (e.g., IL-6, IL-10, Ki-67, etc.) imaging channel and biomarker expression is assessed inside the nuclear footprint (e.g., nuclear expression of the biomarker) or outside of the nuclear footprint (e.g., extra-cellular expression of the biomarker, cytoplasmic expression of the biomarker, etc.). The dimensions of the nuclear mask may be adjusted to increase or decrease the nuclear footprint or can be adapted to identify cell sub-compartments (e.g., cell cytoplasm, cell membrane, etc.) based on nuclear or additional biomarker staining or estimations of cell compartment sizes by the algorithm process.

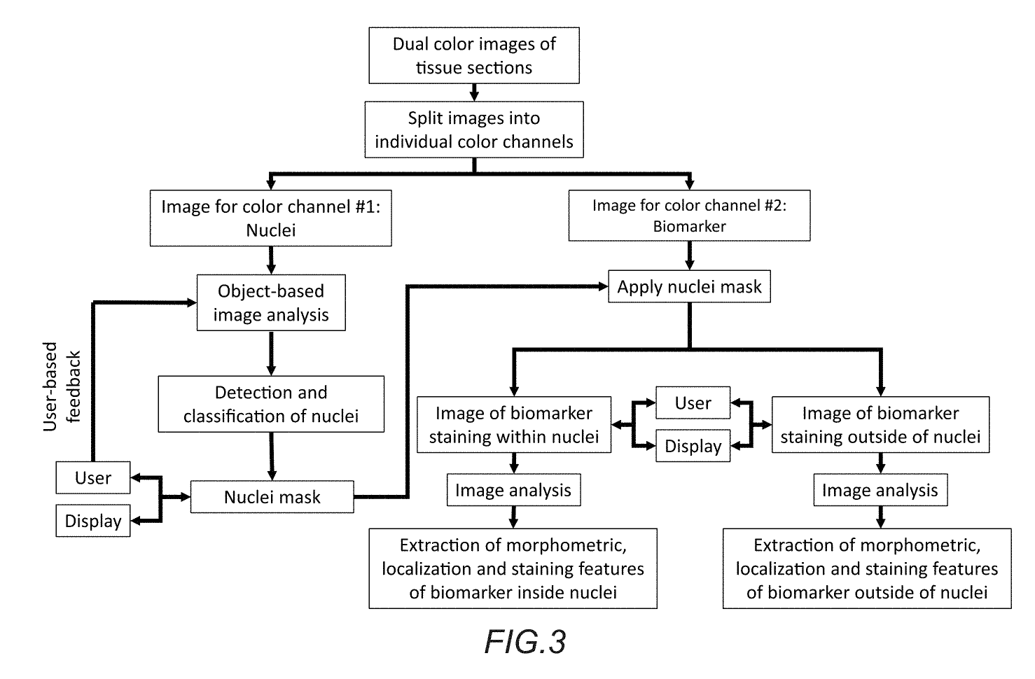

FIG. 3 provides an illustrative example of this preferred embodiment, whereby muscle biopsy tissue blocks stained for a nuclei marker (e.g., DAPI) and a cellular biomarker (e.g., M1 macrophage biomarker IL-6) are evaluated. In this illustrative example, staining is visualized in multiple fluorescence imaging channels. Each color channel captured is evaluated as separate images, but may be displayed as a single overlay of both color channels. Nuclei are identified in the nucleus color channel and the resulting nuclear-object mask is applied to the one or more biomarker channels to identify biomarker staining within and outside the nuclear footprint for each nuclei-object. The morphometric, staining, and localization image analysis features are extracted for biomarker staining inside and outside of each nuclear footprint and are associated with each respective nuclei-object.

In an alternative illustrative example, staining can be visualized based on chromogenic stains and each color channel is determined by color deconvolution.

In an alternative illustrative example, the morphometric and staining image analysis features can be evaluated within and outside of the nuclear footprint irrespective of each nuclei-object and summarize for the entire tissue area or a sub-area.

In another embodiment of this invention, nucleated cells and the associated one or more biomarkers expressed within each cell are evaluated in the context of the muscle fibers located within a tissue section. In this embodiment, stains for the muscle fiber membrane (e.g., spectrin) and/or muscle fiber cytoplasm (e.g., myosin heavy chain) are used to identify individual muscle fibers. The algorithm process identifies individual muscle fiber tissue objects within the image of the tissue section based on the muscle fiber membrane and/or cytoplasm stain and evaluates nuclei and associated biomarker staining relative to individual muscle fibers. One or more morphometric (e.g., nuclear size), staining (e.g., biomarker staining positive), and localization (e.g., x-y coordinate of positive cell) image analysis features for one or more tissue objects (e.g., cell, muscle fiber, nuclei, etc.) can be related to one another to generate novel image analysis endpoints (e.g., IL-6 expressing cells within 30 um of nucleated muscle fibers) which describe the content (e.g., frequency of biomarker positive cells) and context (e.g., localization of biomarker positive cells relative to another stain or tissue object) of biomarker expressing cells within muscle fibers.

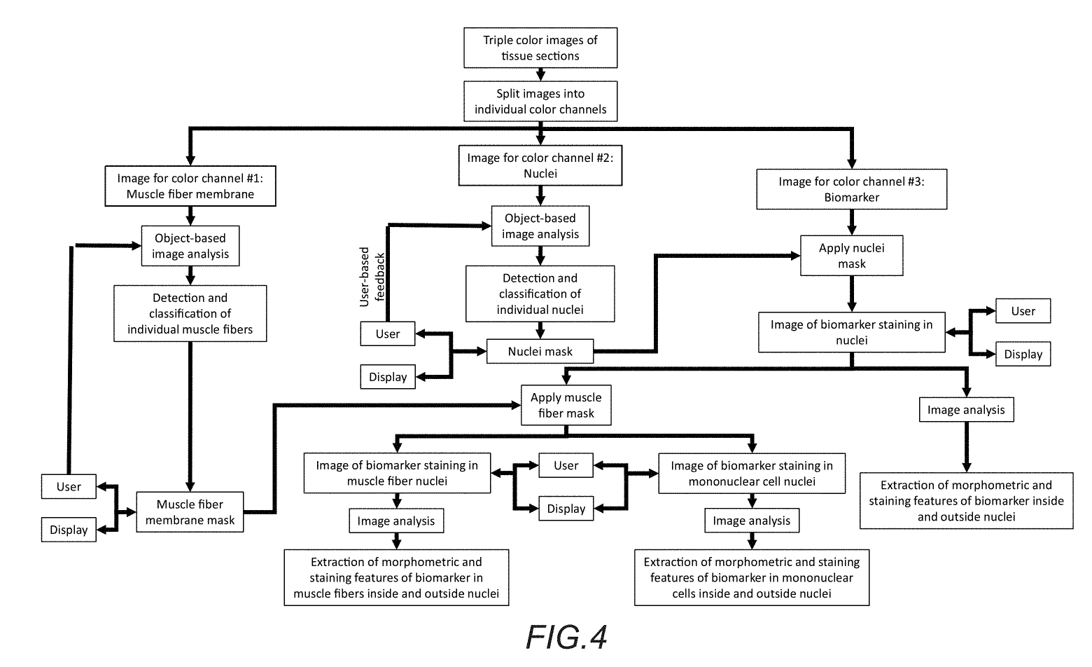

FIG. 4 provides an illustrative example of this preferred embodiment whereby the algorithm process is conFIG.d to assess images of triple-stained tissue sections. For example, and not limitation, the tissue section is fluorescently stained for a biomarker of interest (e.g., IL-6-M1 macrophage), a muscle fiber membrane biomarker (e.g., spectrin), and a nuclear counterstain (e.g., DAPI).

The algorithm processes the original image as three separate images or image layers for each color. In this preferred embodiment of this invention, the image or image layer containing the muscle fiber membrane biomarker staining information is assessed using an algorithm process to detect and classify individual muscle fibers (i.e., muscle fiber objects). The algorithm process then generates a muscle fiber membrane mask based on these objects. This mask is displayed as an overlay on the original image of the tissue section or on the muscle fiber membrane biomarker image or image layer, and reviewed by the user. The user may modify the algorithm process to improve detection and classification of individual muscle fiber membranes.

In this embodiment illustrated by FIG. 4, the resulting muscle fiber mask is applied to the image or image layer containing the nuclei staining information to produce an image where muscle fiber nuclei may be distinguished from non-muscle fiber cell nuclei (e.g., mononuclear cells). The staining, morphometric, and localization features of the nuclei are extracted using the algorithm process implemented by a computer system and can be associated with each respective muscle fiber object (e.g., muscle fiber nuclei, non-muscle fiber nuclei, non-muscle fiber nuclei within a specific distance of a muscle fiber, non-muscle fiber nuclei adjacent to a muscle fiber, etc.).

The algorithm process can then generate a nuclear mask for those muscle fiber and non-muscle fiber nuclei to evaluate biomarker staining. The user may modify the algorithm process to improve detection and classification of mononuclear and muscle fiber nuclei and biomarker staining evaluation.

The resulting muscle fiber and non-muscle fiber nuclei mask(s) are applied to the biomarker stain image (e.g., IL-6-M1 macrophages) or image layer to produce an image of biomarker staining in relation to the muscle fiber nuclei and non-muscle fiber mononuclear cells. The staining, morphometric, and localization features of biomarker expression are extracted using the algorithm process implemented by a computer system and are stored to computer memory or to a database for future processing and analysis.

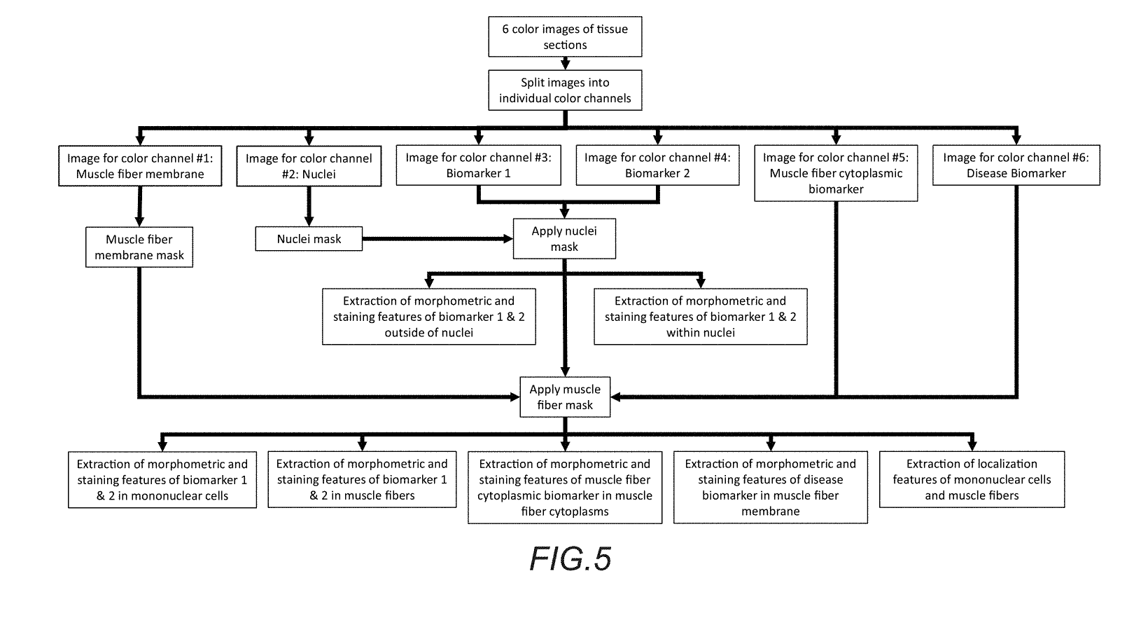

In an alternative embodiment of this invention, the algorithm process is conFIG.d to assess one or more images stained with a plurality of stains for tissue object identifying markers and biomarkers-of-interest. In this embodiment, tissue object identifying markers are analyzed by the algorithm process to identify the appropriate tissue objects of interest (e.g., cell nuclei, muscle fiber membranes, sub-classes of muscle fiber membranes), and the appropriate morphometric, staining, and localization features of tissue objects of interest (e.g., biomarker-positive, biomarker-negative, both biomarker-positive and -negative) are captured and associated (e.g., daughter object feature, distance to, frequency around, etc.) with other tissue objects (e.g., muscle fibers). FIG. 5 provides an illustrative example of this embodiment whereby a tissue section contains six stains to identify nuclei, muscle fiber membranes, two non-muscle fiber nuclei biomarkers, and two muscle fiber biomarkers.

Detection of individual muscle fibers is crucial for distinguishing muscle fiber nuclei from mononuclear nuclei. This invention utilizes two approaches for muscle fiber detection—through detection of muscle fiber membranes or through detection of muscle fiber cytoplasms. Detection of muscle fibers through a muscle fiber membrane biomarker has already been described in U.S. provisional application 62/097,543. Herein, we describe a novel method for muscle fiber detection by using one or more muscle fiber-specific cytoplasmic stain.

An image processing step capable of detecting a cytoplasmic stain (e.g., myosin heavy chain) can be applied to identify muscle fibers. Cytoplasmic staining in muscle fibers can present in a number of different ways (e.g., continuous, punctate, or striated patterns), which can be extracted by the algorithm process (e.g., one or more morphometric and staining feature) to identify and outline the cytoplasmic area of individual muscle fibers.

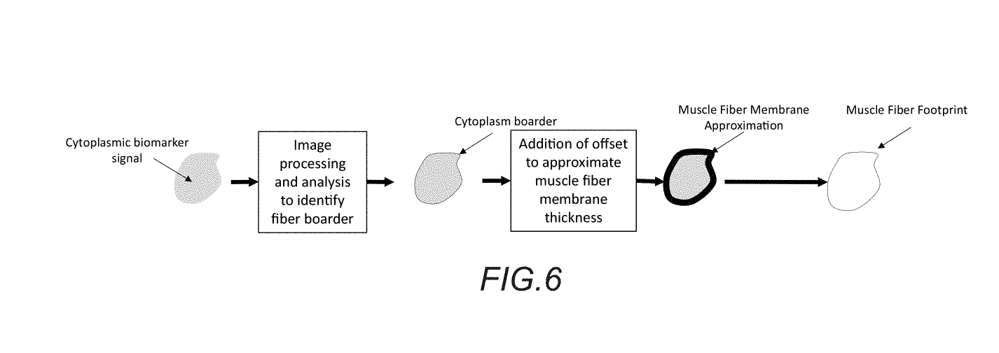

FIG. 6 illustrates the method by which the algorithm process defines the muscle fiber footprint based on a cytoplasmic biomarker stain. The algorithm process identifies the borders of the muscle fiber cytoplasm using the cytoplasm stain. An offset automatically defined by the algorithm process or defined by the user is applied to this border to approximate the muscle fiber membrane. The resulting area covered by the identified muscle fiber and approximated membrane is defined as the muscle fiber footprint for use in later analysis steps.

The morphometric, staining, and localization features of muscle fiber nuclei and non-muscle fiber mononuclear cells can be evaluated by the algorithm process and related to individual muscle fibers once muscle fiber-objects have been identified. These features of muscle fiber nuclei- and mononuclear cell-objects can be evaluated in one or more of the following manners: across the total area of the image, within the muscle fibers or non-muscle fiber mononuclear cells, within a subset of muscle fibers or non-muscle fiber mononuclear cells, and between muscle fibers or non-muscle fiber mononuclear cells. Features related to muscle fiber nuclei- and mononuclear cell-objects can be summarized across an entire image or can be associated with individual muscle fiber objects (e.g., parent objects) to derive summary values for the muscle fiber-object based on the muscle fiber nuclei- and mononuclear cell-object features (daughter objects), or vice versa, on a muscle fiber-by-fiber or cell-by-cell basis.

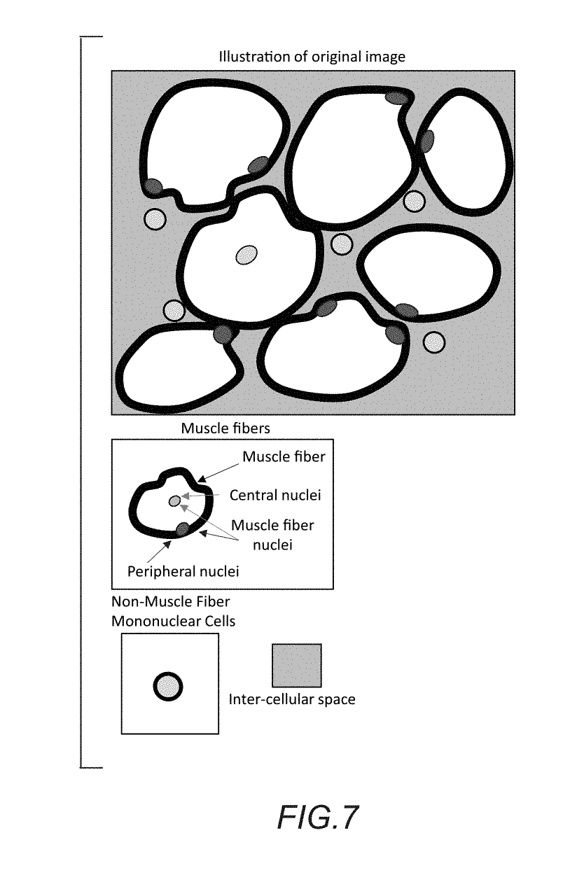

FIG. 7 provides an example of the various sub-classes of nuclei which are identified through this invention and evaluated for biomarker expression. The algorithm process can identify muscle fiber nuclei, associate these with the muscle fiber footprint to classify these nuclei as central or peripheral nuclei, and quantify biomarker expression within each subtype of nuclei (e.g., central or peripheral). Similarly, the algorithm process can identify nuclei which are non-muscle fiber nuclei (e.g., mononuclear cells) and can similarly evaluate biomarker expression within these cell-objects. In one embodiment of this invention, non-muscle fiber cells are associated with the nearest muscle fiber and parameters relating to morphometric and staining features for non-muscle fiber cells are attributed to the nearest muscle fiber. In an alternative embodiment of this invention, the non-muscle fiber cells are evaluated independently of muscle fibers and the morphometric, staining, and localization parameters for the non-muscle fiber cells are attributed to each individual nucleus for summarization on a tissue section-by-section or patient-by-patient manner.

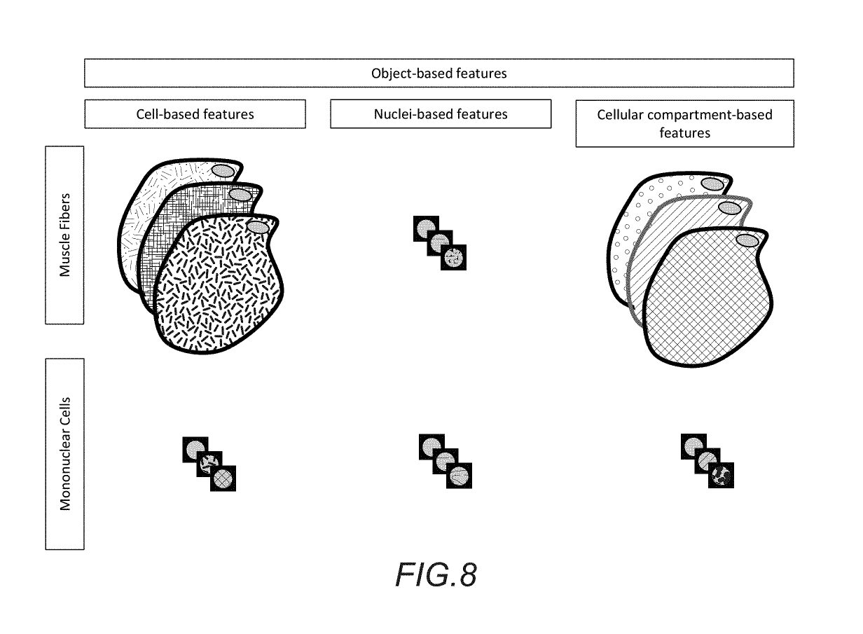

As described, the algorithm process implemented by a computer identifies a number of tissue objects which can be one or more of: muscle fibers, muscle fiber nuclei, muscle fiber cytoplasms, muscle fiber organelle compartments, muscle fiber membranes, non-muscle fiber mononuclear cells, non-muscle fiber mononuclear cell nuclei, non-muscle fiber mononuclear cell cytoplasms, non-muscle fiber organelle compartments, and non-muscle fiber mononuclear cell membranes. The algorithm process extracts a plurality of morphometric and staining features associated with each of these objects. FIG. 8 illustrates this embodiment of the invention whereby a plurality of image analysis feature parameters (grayscale patterns) can be attributed to each tissue object.

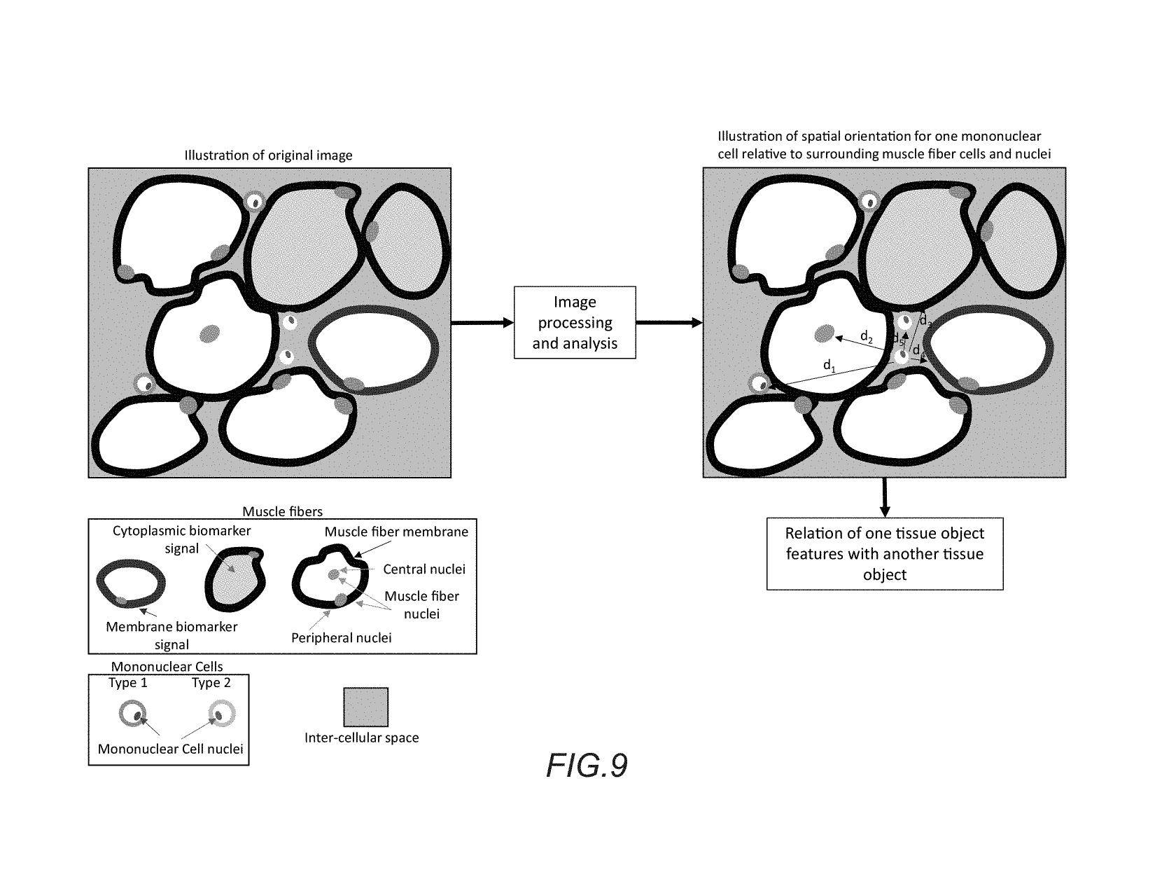

In another embodiment of this invention, the localization features associated with each tissue object can be captured and, optionally, associated with one or more tissue object to describe the relationship between the tissue objects. For example, and not limitation, the respective frequencies of muscle fibers with central nuclei compared with muscle fibers with peripheral nuclei can be determined. Alternatively, non-muscle fiber mononuclear cells can be associated with the nearest muscle fiber based on distance between cell centroids, or the average distance between non-muscle fiber mononuclear cells and a sub-class of muscle fibers could be determined. FIG. 9 demonstrates this embodiment whereby object type (e.g., muscle fiber, muscle fiber nuclei, non-muscle fiber cell) is evaluated along with localization features to determine the spatial relationship between one object (e.g., non-muscle fiber mononuclear cell) and another object (e.g., muscle fiber).

### Derivation of a Patient-Specific Summary Score

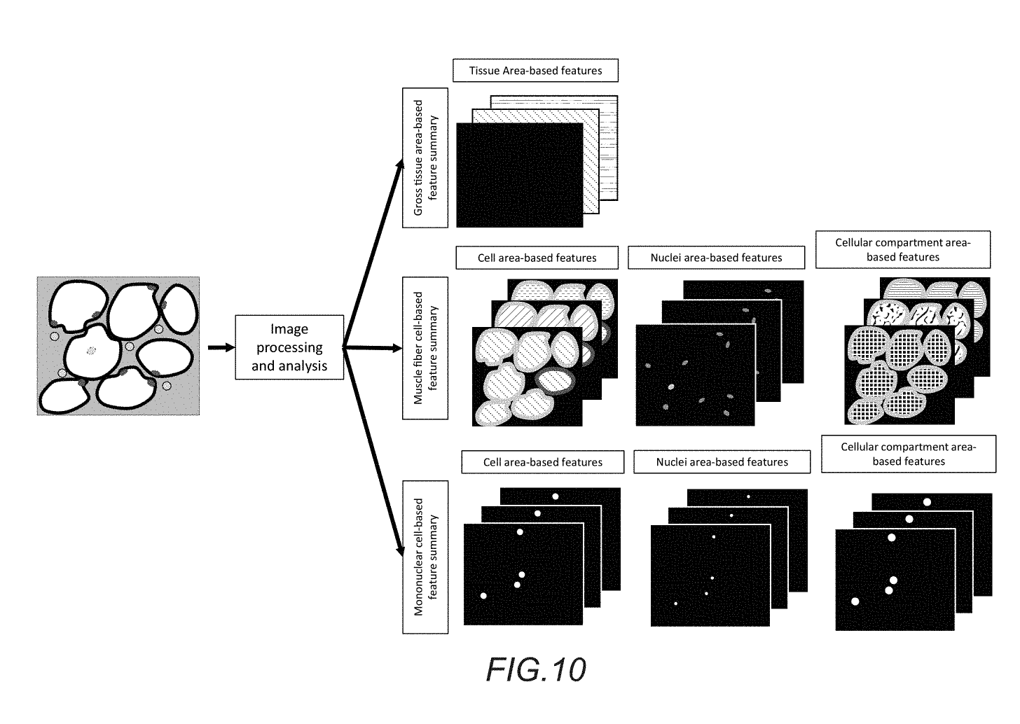

To derive a patient-specific summary score, it is necessary to summarize one or more image analysis features pertaining to the content or context of non-muscle fiber cell objects and muscle fiber cell objects for one or more tissue sections stained and evaluated for a particular patient. The one or more features can be summarized in one or more of the following manners: gross tissue area-based feature summary, muscle fiber-based feature summary, and non-muscle fiber mononuclear cell-based feature summary. FIG. 10 illustrates this aspect of the present invention.

For definition, gross tissue area-based feature summary involves summarizing one or more image analysis features for a tissue object evaluated across an entire tissue section or sub-region. These features are summarized for all pixels located within a specific tissue object (e.g., total area of nuclei, total area of mononuclear cell cytoplasms, etc.). For the purpose of this invention, the tissue objects of interest for this summarization are non-muscle fiber cells and muscle fibers.

For definition, cell-based feature summary involves summarizing one or more image analysis features on a cell-by-cell basis for either muscle fiber cells or non-muscle fiber mononuclear cells (e.g., percentage of biomarker positive nuclei, average biomarker staining in all nuclei, etc.). FIG. 10 illustrates this embodiment whereby there are a plurality of image analysis features which can be derived from and summarized over an entire tissue area within individual muscle and non-muscle fiber cells and cell sub-compartments on a cell-by-cell basis. Furthermore, each image analysis feature summary can be further summarized based on spatial distribution as described above and illustrated in FIG. 9.

In a preferred embodiment of this invention, cell-based feature summary is utilized and each individual object identified by the algorithm process is characterized by staining (e.g., mean staining intensity, maximum staining intensity) and morphometric (e.g., completeness of staining, average width of fiber) features of the biomarker staining within each individual object. Each feature can be summarized for the objects located within the tissue section (e.g., average staining intensity, average completeness of staining), or a sub-region of the tissue section, to capture the histogram statistics of said features (i.e., mean, median, mode, standard deviation, etc.). One or more features can be used (e.g., staining intensity, staining intensity plus staining completeness) to classify individual objects on a continuous (e.g., mean value) or discrete (e.g., negative, low, medium, and high) scale. Each object assessed can be of a specific subtype. For example, biomarker expression can be assessed in only muscle fiber nuclei on a nuclei-by-nuclei basis or for non-muscle fiber mononuclear cells.

Additionally, the locational context of each tissue object can be evaluated in a cell-based feature manner. In this embodiment, cells and/or nuclei are assessed by their proximity to other cells and/or nuclei. For this category of features, muscle fibers and non-muscle fiber cells are identified through one or more of: nuclear, membrane, or cytoplasm stain. The nuclear, membrane, or cytoplasm stain can be from either a biomarker of the cell compartment, biomarker known to localize to a single cell compartment, or counterstain highlighting a specific cell compartment. One or more of the identified tissue objects or tissue object features are then related to another tissue object and summarized for that object (e.g., average distance of mononuclear cells to surrounding mononuclear cells, average staining intensity of mononuclear cells within 15 microns to surrounding mononuclear cells) to classify individual tissue objects on a continuous (e.g., mean value) or discrete (e.g., negative, low, medium, and high; near or far) scale.

For example, the frequency of IL-6 positive cells within 20 microns of IL-10 positive cells could be summarized for a patient to understand the localization of M1 macrophages in relation to M2 macrophages within the muscle tissue for an individual patient.

In another embodiment of the cell-based localization features, non-muscle fiber mononuclear cells are assessed by their proximity to muscle fibers. For this category of features, a mask of the muscle fibers is created through either a muscle fiber membrane or cytoplasm biomarker (e.g., merosin or myosin heavy chain, respectively) to identify the muscle fiber area. Before or after the fiber area has been defined, a mask of the mononuclear cells is created through a histologic nuclei stain (e.g., DAPI) to identify the mononuclear cell area. Each mononuclear cell identified by the algorithm process is then characterized by location relative to the nearest muscle fibers, or nearest group of muscle fibers, (e.g., 2 microns, 2 microns, and 4 microns to the three muscle fibers surrounding a mononuclear cell). Each feature can be summarized for the objects identified across the tissue section (e.g., average distance of mononuclear cells to surrounding muscle fibers, average IL-6 staining intensity of mononuclear cells within 3 microns to surrounding muscle fibers), or a sub-region of the tissue section, to capture the histogram statistics of said features (i.e., mean, median, mode, standard deviation, etc.). One or more features can be used (e.g., staining intensity, distance to closest muscle fiber) to classify individual mononuclear cells on a continuous (e.g., mean value) or discrete (e.g., negative, low, medium, and high; near or far) scale.

For example, the frequency of IL-6 positive mononuclear cells is assessed within 1.5 microns of a muscle fiber membrane to determine the localization of M1 macrophages to individual muscle fibers.

In another similar embodiment of the localization features, mononuclear cells are assessed by their proximity to muscle fiber sub-types. For this category of features, a mask of the muscle fibers is created through either a muscle fiber membrane or cytoplasm biomarker (e.g., merosin or myosin heavy chain, respectively) to identify the muscle fiber area. After the fiber area has been defined, one or more muscle fiber sub-types are determined by additional biomarker stains which are specific for one or more sub-type of muscle fiber.

For example, dystrophin expression may help identify the muscle fiber membrane while fast myosin expression in the cytoplasm would be indicative of a fast twitch muscle fiber.

Each mononuclear cell identified by the algorithm process is then characterized by location relative to the nearest muscle fiber, or cluster of similar muscle fiber, sub-type of interest (e.g., distance to the nearest slow twitch muscle fibers). Each feature can be summarized for the objects identified within a tissue section (e.g., average distance of mononuclear cells to surrounding slow twitch muscle fibers, average staining intensity of mononuclear cells within 20 microns to surrounding fast twitch muscle fibers), or a sub-region of the tissue section, to capture the histogram statistics of said features (i.e., mean, median, mode, standard deviation, etc.). One or more features can be used (e.g., staining intensity, distance to closest muscle fiber) to classify individual mononuclear cells on a continuous (e.g., mean value) or discrete (e.g., negative, low, medium, and high; near or far) scale.

For example, the frequency of IL-6 positive mononuclear cells is assessed within 10 microns of a slow twitch muscle fiber.

### Inferring Disease Status for Each Patient Based on a Summary Score

One or more summary value describing muscle fiber nuclei and/or non-muscle mononuclear cell image analysis features are derived and a mathematical expression is used to combine the values for one or more parameters relating to one or more categories of biomarker expression features and/or one or more categories of mononuclear cell and/or muscle fiber location to derive a score of the disease status for each patient. The mathematical expression can combine values for parameters in one or more of: linear, non-linear, and logical operator fashion. A value for an image analysis derived parameter can be one of the histogram statistics (e.g., mean, standard deviation, skewness) describing the distribution of said parameter values in the tissue.

The patient-specific summary value or score is evaluated relative to pre-defined patient stratification criteria to determine to which of two or more patient strata each patient belongs based on said summary value or score. One or more of these patient strata relate to known or expected disease presence, disease state, response profile to a specific therapy, predicted response to a specific therapy, or natural progression of the disease. A user infers disease state, severity of disease, response to a therapeutic intervention, prognosis, or eligibility for a particular therapy based on each patient's strata membership.

What is claimed is:

1. A method comprising:
obtaining at least one muscle biopsy tissue sample from a patient;
processing the muscle biopsy tissue sample with at least one histologic practice to produce at least one stained tissue section;
capturing a digital image of the stained tissue section;
applying an algorithm process implemented by a computer to at least one of the digital images to extract at least one image analysis feature, wherein image analysis features are selected from the group consisting of staining, morphometric, and localization features;
overlaying the image analysis feature on the digital image creating an overlaid digital image;
relating at least one first object to at least one second object from the overlaid digital image, wherein the first object and second object are selected from the group consisting of tissue objects, tissue object analysis features, and non-cellular material.

2. The method of claim 1, wherein the at least one histologic practice are stains selected from the group consisting of immunohistochemistry chromogenic stains, immunofluorescent fluorescent stains, and standard histologic dyes.

3. The method of claim 1, wherein the at least one histology practice highlight at least one biomarker selected from the group consisting of cells, cell sub-compartments, cell subtypes, tissue compartments, and other biomarkers.

4. The method of claim 3, wherein cell sub-compartments are selected from the group consisting of nucleus, cytoplasm, membrane, and cell organelles.

5. The method of claim 1, wherein the histology practices allow inferences selected from the group consisting of underlying biology mechanisms, status, phenomena, and presence of a drug, and the biomarker is selected from the group consisting of proteins, lipids, carbohydrates, DNA sequences, and RNA sequences.

6. The method of claim 1, wherein the digital image is captured via a method selected from the group consisting of bright-field, fluorescence, bright-field equivalent of fluorescence, combination bright-field/fluorescence, in situ mass spectrometry, and methods that generate a dataset which associates a specific analyte or biomolecule and its concentration at a specific location on a tissue section.

7. The method of claim 1, wherein the tissue objects further comprise non-cellular biologic material and groups of cells.

8. The method of claim 1, wherein the morphometric features characterize physical parameters of tissue objects, wherein the physical characteristics are selected from the group consisting of size, shape, and texture.

9. The method of claim 1, wherein the localization features are selected from the group consisting of absolute x-y image coordinates, relative x-y image coordinates, absolute polar coordinates, relative polar coordinates, absolute complex coordinates, relative complex coordinates, absolute spherical coordinates, relative spherical coordinates, and pixel coordinates.

10. The method of claim 1, wherein the algorithm is applied to a digital image captured by a first technique and the image analysis feature is overlaid on a digital image captured by a second technique, wherein the techniques are bright-field, fluorescence, bright-field equivalent of fluorescence, combination bright-field/fluorescence, in situ mass spectrometry, and methods that generate a dataset which associates a specific analyte or biomolecule and its concentration at a specific location on a tissue section.

11. The method of claim 1, further comprising manipulating the image analysis features using mathematical operations to describe a relationship between a first image analysis object and a second image analysis object, wherein the mathematical operations are selected from the group consisting of arithmetic operators, linear combinations, non-linear combinations, and logical operators, and the first image analysis object and second image analysis object are selected from the group consisting of tissue objects and tissue object features.

12. The method of claim 1, wherein the digital image includes at least one parent object and at least one daughter object, and wherein the image analysis features define a relationship between the parent object and the daughter object.

13. The method of claim 1, wherein the image analysis features define a spatial relation between at least one first tissue object sub-class and at least one second tissue object sub-class.

14. The method of claim 13, wherein the spatial relation is selected from the group consisting of distance measurement, frequency of tissue objects from a tissue object sub-class within a distance from a tissue object, frequency of tissue objects from a tissue object sub-class within a distance from a tissue object sub-class, frequency of tissue objects from a tissue object sub-class within a range of distances from a tissue object, frequency of tissue objects from a tissue object sub-class within a range of distances from a tissue object sub-class, density of tissue objects from a tissue object sub-class within a distance from a tissue object, density of tissue objects from a tissue object sub-class within a distance from a tissue object sub-class, density of a first tissue object from a tissue object sub-class spatially coincident with density of a second tissue object, density of tissue objects from a tissue object subclass spatially coincident with density a tissue object sub-class.

15. The method of claim 1, wherein the image analysis feature is derived from a histogram statistic of the image analysis feature and is used to generate a patient-specific summary score by mathematical operations, wherein the mathematical operations are selected from the group consisting of arithmetic operators, linear combinations, non-linear combinations, and logical operators.

16. The method of claim 1 further comprising:
applying patient stratification criteria to the patient-specific score of disease status to determine patient strata membership; and
drawing inferences for the patient based on patient strata membership, where the inferences are selected from the group consisting of disease state, disease severity, efficacy of a therapeutic intervention, prognosis, and eligibility for a particular therapy.

17. The method of claim 16, wherein the patient strata membership is for at least two patient strata.

18. The method of claim 17, wherein at least one of the patient strata correspond to a medically relevant status, wherein medically relevant status is selected from the group consisting of disease presence, disease status, disease severity, natural course of disease, efficacy of a therapeutic intervention, and response to a therapeutic intervention.

19. The method of claim 1 further comprising annotating the digital image with at least one digital annotation to limit regions of analysis of the digital image.
